(19) United States
(12) Patent Application Publication
(10) Pub. No.: US 2015/0063577 A1
(43) Pub. Date: Mar. 5, 2015

(54) SOUND EFFECTS FOR INPUT PATTERNS

(71) Applicant: Samsung Electronics Co., Ltd., Gyeonggi-do (KR)

(72) Inventors: Ji-Tae SONG, Gyeonggi-do (KR); Seong-Hwan KIM, Gyeonggi-do (KR); Sang-Hee PARK, Gyeonggi-do (KR); Hyun-Soo KIM, Gyeonggi-do (KR); Jung-Won LEE, Incheon (KR); Eun-Jung HYUN, Seoul (KR)

(21) Appl. No.: 14/468,762

(22) Filed: Aug. 26, 2014

(30) Foreign Application Priority Data
Aug. 29, 2013 (KR) 10-2013-0103513

(51) Int. Cl. G10H 5/00

(52) U.S. Cl. CPC G10H 5/00
USPC 381/61

(57) ABSTRACT

Disclosed herein are a method and device for generating sound effects. Features of an input pattern are detected. A sound that reflects the input pattern is synthesized and played.

### CLAIM OF PRIORITY

This application claims priority under 35 U.S.C. §119(a) to a Korean Patent Application filed in the Korean Intellectual Property Office on Aug. 29, 2013 and assigned Serial No. 10-2013-0103513, the entire disclosure of which is hereby incorporated by reference.

### BACKGROUND

1. Field of the Disclosure

The present disclosure relates to a method for generating a sound effect and an electronic device thereof.

2. Description of Related Art

Due to the recent growth of multimedia technology, multi-functional electronic devices are now prevalent in today's society. Generally, these electronic devices may perform many complex functions. Some conventional electronic devices are mobile terminals typically known as “smart phones.” Such mobile terminals may include a large touch screen. In addition to being a mobile phone, these mobile terminals may include a high-pixel camera module to take still and moving pictures; may playback multimedia content, such as music, a video and the like; or may gain access to a network.

Therefore, various functions are gradually converging into electronic devices. Also, the performance of these electronic devices are gradually increasing due to the high-performance processors installed therein. Because mobile terminals have made considerable progress, the phone aspect of the terminal is considered a supplementary function. Electronic devices today may interface with users and provide graphic or audio output in response to a user's input.

### SUMMARY

Various examples of the present disclosure provide a sound effect generating method and electronic device capable of providing audio feedback in response to a user's input. The method and electronic device of the present disclosure may provide a natural audio feedback in accordance with a user's motion. The sound generated by the techniques disclosed herein may be intuitive in view of the input.

In one aspect, an operation method of an electronic device may include obtaining features associated with a detected input pattern; obtaining a basic sound effect; synthesizing a sound effect that reflects the features associated with the input pattern, the sound effect being based at least partially on the basic sound effect; and playing the synthesized sound effect.

In a further aspect, an electronic device may include at least one processor to: detect an input pattern; identify features associated with the input pattern; obtain a basic sound effect; synthesize a sound effect that reflects the features associated with the input pattern, the sound effect being based at least partially on the basic sound effect; and play the synthesized sound effect.

### BRIEF DESCRIPTION OF THE DRAWINGS

The above and other aspects, features and advantages of the present disclosure will become more apparent from the following detailed description when taken in conjunction with the accompanying drawings in which:

FIG. 1 is a perspective view illustrating an example electronic device in accordance with aspects of the present disclosure;

FIG. 2A is a block diagram illustrating example components of an electronic device in accordance with aspects of the present disclosure;

FIG. 2B is a block diagram illustrating an example processor in accordance with aspects of the present disclosure;

FIG. 3 is a working example of audio feedback making use of distance information in accordance with aspects of the present disclosure;

FIG. 4 is a flowchart illustrating an example method in accordance with aspects of the present disclosure;

FIG. 5 is a flowchart illustrating another example method in accordance with aspects of the present disclosure;

FIG. 6 is a flowchart illustrating yet another example method in accordance with aspects of the present disclosure;

FIG. 7 is a flowchart illustrating yet a further example method in accordance with aspects of the present disclosure;

FIG. 8A and FIG. 8B are working examples of a playback section in accordance with aspects of the present disclosure; and

FIG. 9 is a flowchart illustrating another example method in accordance with aspects of the present disclosure.

### DETAILED DESCRIPTION

Various examples of the present disclosure will be described herein with reference to the accompanying drawings. It is understood that various modifications may be made to the examples without departing from the spirit and scope of the present disclosure. As such, it is understood that the examples herein include all changes, equivalents or alternatives of the illustrations described herein. In a description of the drawings, like reference numerals are used for like components.

The expressions such as “comprise”, “include”, “may include”, “may comprise” and the like may indicate the existence of a disclosed function, operation, component and the like. Also, it should be understood that the terms such as “comprise”, “include”, and “have” designate the existence of a feature stated in the specification, a number, a step, an operation, a component, or a combination thereof, and do not exclude the existence of one or more other features, numbers, steps, operations, components, or combinations thereof.

Expressions such as “or”, “at least one of A or/and B”, or the like include any and all combinations of words enumerated together. For example, “A or B” or “at least one of A or/and B” each may include “A”, or may include “B”, or may include both “A” and “B”.

Expressions such as “1st”, “2nd”, “first”, “second” and the like may modify various elements, but do not limit these elements. For example, the expressions do not limit the order of the elements, or the importance thereof. The expressions may be used to distinguish one element from another element. For example, a 1st electronic device and a 2nd electronic device are all electronic devices, and represent different electronic devices.

When an element is “connected” to or “accessed” by another element, it should be understood that any element may be directly connected to or accessed by another element or that a third element may also exist between the two elements. In contrast, when any element is “directly connected” to or “directly accessed” by another element, it should be understood that the third element does not exist between the two elements.

The terms employed in the present disclosure are used for describing specific examples, and do not intend to limit the spirit and scope of the various examples herein. The expression of a singular number includes the expression of a plural number unless the context clearly dictates otherwise.

Unless defined otherwise, all terms used herein including technological or scientific terms have the same meaning as being generally understood by one of ordinary skill in the art. Terms as defined in a general dictionary should be interpreted as having meanings consistent with a contextual meaning of a related technology, and are not interpreted as having ideal or excessively formal meanings unless defined clearly herein.

An electronic device may be a device including a telecommunication function. For example, the electronic device may include at least one of a smart phone, a tablet Personal Computer (PC), a mobile phone, a video phone, an electronic book (e-book) reader, a desktop PC, a laptop PC, a netbook computer, a Personal Digital Assistant (PDA), a Portable Multimedia Player (PMP), an MPEG Audio Layer 3 (MP3) player, a mobile medical instrument, a camera, and a wearable device (e.g., a Head-Mounted Display (HMD) such as electronic glasses, electronic clothes, an electronic bracelet, an electronic necklace, an accessory, an electronic tattoo, or a smart watch).

In a further example, the electronic device may be a smart home appliance with a telecommunication function. For example, the smart home appliance may include at least one of a television, a Digital Video Disk (DVD) player, an audio system, a refrigerator, an air conditioner, a cleaner, an oven, a microwave, a washing machine, an air cleaner, a set-top box, a TV box (for example, Samsung HomeSync™, Apple TV™, or Google TV™), a game console, an electronic dictionary, an electronic locking system, a camcorder, and an electronic frame.

In a further example, the electronic device may include at least one of a variety of medical instruments (e.g., Magnetic Resonance Angiography (MRA), Magnetic Resonance Imaging (MRI), Computerized Tomography (CT), a scanning machine, an ultrasound machine and the like), a navigation device, a Global Positioning System (GPS) receiver, an Event Data Recorder (EDR), a Flight Data Recorder (FDR), a car infotainment device, an electronic equipment for ship (e.g., a navigation device for ship, a gyrocompass and the like), avionics, a security instrument, and an industrial or household robot.

In a further example, the electronic device may include at least one of a part of furniture or building/structure having a telecommunication function, an electronic board, an electronic signature receiving device, a projector, and various metering instruments (e.g., a tap water, electricity, gas, radio wave metering instrument or the like).

The electronic device may be one or a combination of more of the aforementioned devices. Also, the electronic device may be a flexible device. Also, it is understood that the electronic device is not limited to the aforementioned instruments.

An example electronic device will be described below with reference to the accompanying drawings. The term ‘user’ may denote a person who uses the electronic device. The term ‘user’ may also refer to another device (e.g., an artificial intelligence electronic device) that uses the electronic device. In one example, the term ‘sound effect’ may include sound source.

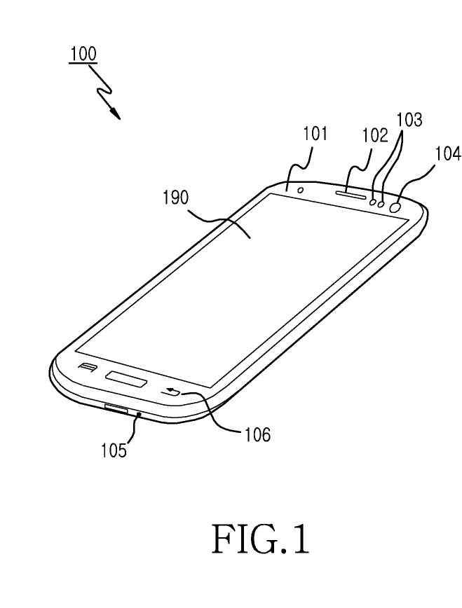

Referring to FIG. 1, a touch screen 190 may be installed in front 101 of the electronic device 100. The touch screen 190 may display an electrical signal provided from the electronic device 100 as a picture such as a text, a graphic, a video and the like. Also, the touch screen 190 displays output in response to input. The touch screen 190 may receive data with an input means such as a finger or a stylus.

In one example, the touch screen 190 may employ not only capacitive, resistive, infrared and surface acoustic wave technologies but also any multi-touch sensing technology including other proximity sensor arrays or other elements. Through a variation of a physical quantity (for example, capacitance, resistance and the like) of contact with a finger, a stylus or the like, the touch screen 190 may recognize a touch, and sense operations such as flicking, a touch and drag, a tap and hold, a multi tap and the like. Also, the touch screen 190 may recognize a hovering input (also called a non-contact touch or a proximity touch) sensing that an input means such as a finger or a stylus approaches within a certain distance from touch screen 190.

An earpiece 102 for receiving a voice may be installed at an upper side of the touch screen 190. A plurality of sensors 103 such as a proximity sensor, a light sensor or the like and a camera device 104 for photographing or recording video of a subject may be installed around the earpiece 102.

In one example, the electronic device 100 may further include a microphone device 105 located at a lower side of the touch screen 190 and receiving an input of sound, and a keypad device 106 arranging key buttons. Electronic device 100 may also comprise additional components that are not shown for implementing additional functions.

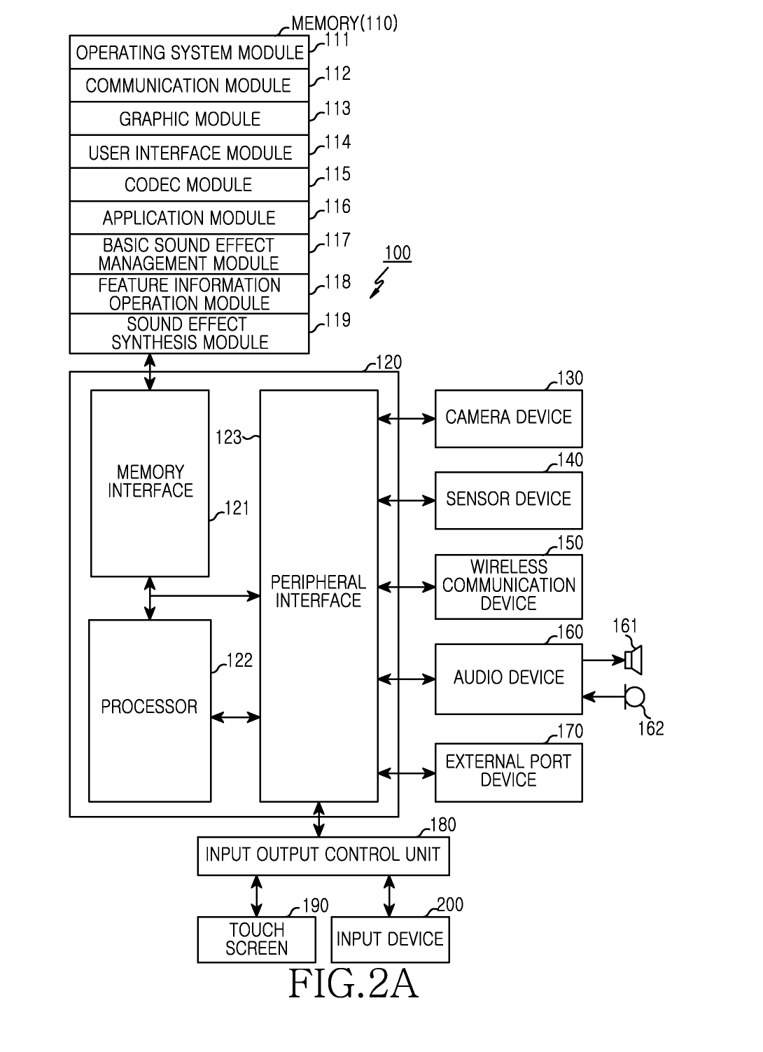

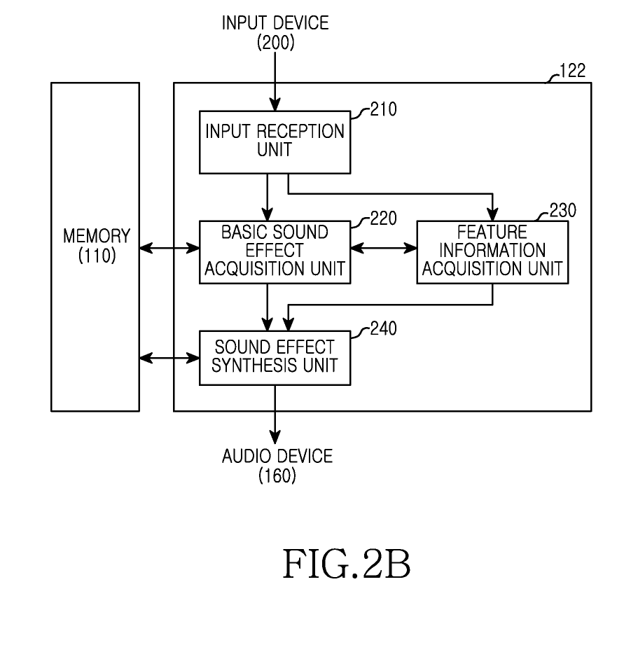

Referring now to FIG. 2A, the electronic device 100 may include a memory 110, a processor unit 120, a camera device 130, a sensor device 140, a wireless communication device 150, an audio device 160, an external port device 170, an input output control unit 180, a touch screen 190, and an input device 200. The memory 110 and the external port device 170 may be constructed in plural. Each component is described as follows.

The processor unit 120 may include a memory interface 121, at least one processor 122, and a peripheral interface 123. Here, the memory interface 121, the at least one processor 122 and the peripheral interface 123 included in the processor unit 120 may be integrated as at least one integrated circuit or be implemented as separate components.

The memory interface 121 may control the access of the component such as the processor 122 or the peripheral interface 123 to the memory 110. The peripheral interface 123 may control the connection of the memory interface 121 and the processor 122 with an input output peripheral device of the electronic device 100.

The processor 122 may control the electronic device 100 to provide various multimedia services using at least one software program. The processor 122 may execute at least one program stored in the memory 110 and provide a service corresponding to the corresponding program. The processor 122 may execute several software programs, perform several functions of the electronic device 100, and may perform processing and control for voice communication, video communication and data communication. Further, the processor 122 may interwork with software modules stored in the memory 110 and perform illustrative methods of the present disclosure.

The processor 122 may include one or more data processors, image processors, or CODECs. Further, the data processor, the image processor, or the CODEC may be separate or remote from electronic device 100. Various components of the electronic device 100 may be connected through one or more communication buses (not denoted by reference numerals) or electrical connection means (not denoted by reference numerals).

The camera device 130 may perform a camera function such as photo, video clip, recording and the like. The camera device 130 may include a Charged Coupled Device (CCD), a Complementary Metal-Oxide Semiconductor (CMOS) or the like. Further, the camera device 130 may perform hardware construction change, for instance, lens shift, iris count adjustment, and the like in accordance with a camera program executed by the processor 122.

The sensor device 140 may include a proximity sensor, a hall sensor, a light sensor, a motion sensor, and the like. For example, the proximity sensor may sense an object approaching the electronic device 100, and the hall sensor may sense a magnetic force of a metal body. Also, the light sensor senses light around the electronic device 100. The motion sensor may include an acceleration sensor or gyro sensor sensing a motion of the electronic device 100. However, it is understood that sensor device 140 is not limited to the forgoing, and the sensor device 140 may also include various sensors for implementing additional functions.

The wireless communication device 150 makes possible wireless communication, and may include a wireless frequency transmitter/receiver or an optical (e.g., infrared) transmitter/receiver. Though not illustrated, the wireless communication device 150 may include a Radio Frequency (RF) IC unit and a baseband processor. The RF IC unit may transmit/receive an electromagnetic wave, and may convert a baseband signal from the baseband processor into an electromagnetic wave and transmit the electromagnetic wave through an antenna.

The RF IC unit may include an RF transceiver, an amplifier, a tuner, an oscillator, a digital signal processor, a CODEC chipset, a Subscriber Identification Module (SIM) card, and the like.

The wireless communication device 150 may be implemented to operate through at least one of a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Fidelity (Wi-Fi) network, a Wireless interoperability for Microwave Access (WiMAX) network, a Near Field Communication (NFC) network, an infrared communication network, and a Bluetooth network in accordance with a communication network. But, it is not limited to this, and the wireless communication device 150 may apply several communication methods using an electronic mail (e-mail), instant messaging, or a Short Message Service (SMS) protocol.

The audio device 160 may be connected to the speaker 161 and the microphone 162 and perform an audio input and output function of a voice recognition, voice replication, digital recording, call function or the like. The audio device 160 may provide an audio interface between a user and the electronic device 100, and may convert a data signal received from the processor 122 into an electrical signal and output the converted electrical signal through the speaker 161.

The speaker 161 may convert an electrical signal into an audible frequency band and output the audio frequency band. The speaker 161 may be arranged in front or rear of the electronic device 100. The speaker 161 may include a flexible film speaker attaching at least one piezoelectric body to one vibration film.

The microphone 162 may convert a sound wave forwarded from human or other sound effects into an electrical signal. The audio device 160 may receive the electrical signal from the microphone 162, convert the received electrical signal into an audio data signal, and transmit the converted audio data signal to the processor 122. The audio device 160 may include an earphone, an ear set, a headphone or a headset which is attachable to or detachable from the electronic device 100.

The external port device 170 may directly connect the electronic device 100 with a counterpart electronic device, or indirectly connect the electronic device 100 with the counterpart electronic device through a network (e.g., the internet, an intranet, a wireless LAN and the like). The external port device 170 may include a Universal Serial Bus (USB) port, a FIREWIRE port, or the like.

The input output control unit 180 may provide an interface between an input output device such as the touch screen 190, the input device 200 and the like, and the peripheral interface 123. The input output control unit 180 may include a touch screen controller and other input device controller.

The touch screen 190 may provide an input and output interface between the electronic device 100 and a user. The touch screen 190 may apply a touch sensing technology to forward user information to the processor 122, and show visual information, a text, a graphic, a video or the like provided from the processor 122 to the user.

The touch screen 190 may display status information of the electronic device 100, a text inputted by a user, a moving picture and a still picture. Further, the touch screen 190 may display information related to an application driven by the processor 122.

The touch screen 190 may apply not only capacitive, resistive, infrared, and surface acoustic technologies but also any multi touch sensing technology including other proximity sensor arrays or other elements. This touch screen 190 may apply at least one of a Liquid Crystal Display (LCD), an Organic Light-Emitting Diode (OLED), an Active-Matrix Organic Light-Emitting Diode (AMOLED), a Thin Film Transistor—Liquid Crystal Display (TFT-LCD), a flexible display, and a 3-Dimensional (3D) display.

The touch screen 190 may recognize a touch through a variation of a physical quantity (for example capacitance, resistance and the like) in accordance with a contact of a finger, a stylus or the like, and sense operations such as flicking, a touch and drag, a tap and hold, a multi tap and the like. Also, the touch screen 190 may be implemented to recognize a hovering input (also called a non-contact touch or a proximity touch) sensing that an input means such as a finger or a stylus approaches within a certain distance with the touch screen 190.

The input device 200 may provide input data generated by user's selection to the processor 122 through the input output control unit 180. The input device 200 may include a keypad including at least one hardware button, and a touch pad sensing touch information.

The input device 200 may include an up/down button for volume control. Besides this, the input device 200 may include at least one of a push button assigned a corresponding function, a locker button, a rocker switch, a thumb-wheel, a dial, a stick, a mouse, a track ball, and a pointer device such as a stylus and the like.

The memory 110 may include one or more high-speed random access memories or non-volatile memories such as magnetic disk storage devices, one or more optical storage devices or flash memories (for example, Not AND (NAND) memories, Not OR (NOR) memories).

The memory 110 may store software. This software may include, but is not limited to, an operating system module 111, a communication module 112, a graphic module 113, a user interface module 114, a CODEC module 115, an application module 116, a basic sound effect management module 117, a feature information operation module 118, and a sound effect synthesis module 119. The term of ‘module’ may be expressed as a set of instructions, an instruction set, or a program.

The operating system module 111 may include an embedded operating system such as WINDOWS, LINUX, Darwin, RTXC, UNIX, OS X, Android or VxWorks, and may include various software components controlling general system operation. Control of the general system operation may include memory control and management, storage hardware (device) control and management, power control and management, and the like. Further, the operating system module 111 may perform a function of making smooth communication between various hardware (devices) and software components (modules).

The communication module 112 may make possible communication with a counterpart electronic device such as a computer, a server, an electronic device and the like, through the wireless communication device 150 or the external port device 170.

The graphic module 113 may include various software components for providing and displaying a graphic on the touch screen 190. The term of ‘graphic’ may signify a text, a web page, an icon, a digital image, a video, an animation and the like.

The user interface module 114 may include various software components associated with a user interface. The user interface module 114 may control to display on the touch screen 190 information related to an application driven by the processor 122. Also, the user interface module 114 may include information about how a state of a user interface is changed, whether the change of the state of the user interface is carried out in which condition, or the like.

The CODEC module 115 may include a software component related to encoding and decoding of a video file.

The application module 116 may include a software component for at least one application installed in the electronic device 100. This application may include a browser, an e-mail, a phonebook, a game, a short message service, a multimedia message service, a Social Networking Service (SNS), an instant message, a wake-up call, MP3, schedule management, a paint, a camera, word processing, keyboard emulation, a music player, an address book, a touch list, a widget, Digital Right Management (DRM), voice recognition, voice replication, a position determining function, a location-based service, and the like. The term of application is expressed as an application program as well.

The basic sound effect management module 117 may store a basic sound effect for sound effect synthesis, and may include a software component for controlling a basic sound effect which is output in response to a detected input pattern. The basic sound effect management module 117 includes a previously recorded basic sound effect, and may store the basic sound effect in a Pulse Code Modulation (PCM) format. Also, the basic sound effect management module 117 may include related processes and instructions for generating the basic sound effect.

The feature information operation module 118 may include a software component for identifying features in a detected input pattern. The feature information operation module 118 may include related processes and instructions for determining collected feature information and generating a parameter value for sound effect synthesis.

The sound effect synthesis module 119 may include a software component for altering a basic sound effect using the features identified in the input pattern. The sound effect synthesis module 119 may include related processes and instructions for adapting the collected features to a physical modeling standard and altering the basic sound effect based on the standard.

The processor unit 120 may further include additional modules (instructions) besides the aforementioned modules. Various functions of the electronic device 100 may be executed by hardware, software, or Application Specific Integrated Circuits (ASICs).

Though not illustrated, the electronic device 100 may include a power system for supplying power to several components included in the electronic device 100. The power system may include a power source (i.e., an alternating current or a battery), a power error detection circuit, a power converter, a power inverter, a charging device, or a power level indicating device (e.g., a light emitting diode). Further, the electronic device 100 may include a power management and control device performing a power generation, management and distribution function.

In the present example, the components of the electronic device 100 are illustrated and described, but it is understood that electronic device 100 is not limited to the foregoing. That is, the electronic device 100 may have more or less components than illustrated in the present drawing.

Referring now to FIG. 2B, the processor 122 may include an input reception unit 210, a basic sound effect acquisition unit 220, a feature information acquisition unit 230, and a sound effect synthesis unit 240. In one example, components of the processor 122 may be constructed as separate modules, but may be included in one module as components of software.

The input reception unit 210 may detect an input pattern detected by a user. The user may employ a body part (e.g., a finger) or a separate input device 200 to enter input.

In one example, when input reception unit 210 detects an input pattern, the input reception unit 210 may sense a motion of a human body such as a motion of a user's finger or eye and the like, and recognize the sensed motion as the input pattern. This input reception unit 210 may include a touch sensor for recognizing the user's finger, and may include a camera sensor for recognizing the user's eye. However, input reception unit 210 may be able to recognize a motion of any human body part.

In another example, when the input reception unit 210 receives an input pattern using the separate input device 200, the input reception unit 210 may sense a motion of an input means such as a stylus pen, a mouse, a track ball and the like, and recognize the sensed motion as the input pattern. This input reception unit 210 may include a touch panel or separate sensor for recognizing the separate input device 200.

In one example, the input reception unit 210 may digitize an input pattern (for example, a continuous input coordinate, input speed and the like) received from the user or the separate input device 200, into an input pattern value. Also, the input reception unit 210 may digitize the input pattern received at a certain time interval or in real-time, and may provide the digitized input pattern value to the basic sound effect acquisition unit 220 or the feature information acquisition unit 230.

The basic sound effect acquisition unit 220 may execute the basic sound effect management module 117 stored in the memory 110 and provide a basic sound effect for sound effect synthesis in the sound effect synthesis unit 240. For example, the basic sound effect may be stored in the memory 110 in a PCM format.

In one example, the basic sound effect acquisition unit 220 may load a previously recorded basic sound effect stored in the basic sound effect management module 117. This basic sound effect may include various sounds, for example, a ball point pen sound, a fountain pen sound, a pencil sound, a chalk sound, a felt-tip pen sound, a brush sound and the like. Thus, the sound may be a sound associated with the input pattern.

In another example, when the basic sound effect acquisition unit 220 uses the previously recorded basic sound effect, the electronic device 100 may select a sound effect that is associated with the type of input (e.g., the kind of a pen and the like). For example, when using a ball point pen, the electronic device 100 may be able to generate a ball point pen sound effect. Electronic device 100 may identify the ball point pen based on the input pattern. The sound effect associated with the detected input pattern is not limited to the kind of the pen; it is understood that various inputs may be applied with various basic sound effects associated with the inputs. For example, if the electronic device 100 receives an input pattern by the user's touch (for example, the finger and the like), the electronic device 100 may play the previously recorded basic sound effect matching the input pattern generated by the touch. In yet a further example, the basic sound effect acquisition unit 220 may synthesize a sound effect in accordance with a detected input, using a frequency synthesis method. For example, the basic sound effect acquisition unit 220 may include a basic sound effect synthesis device which is comprised of a white noise generator, a Low Frequency Oscillator (LFO), and an audio filter.

In one example, the basic sound effect synthesis device may generate a white noise by applying a frequency of a detected input pattern to a random function through the white noise generator. Also, the basic sound effect synthesis device may generate a low frequency signal through the LFO using the generated white noise, modulate the generated low frequency signal, and synthesize a sound effect via the audio filter. For example, a setting value of the random function applied upon basic sound effect synthesis, a setting value of the LFO, a coefficient of the audio filter, and the like may be selected in accordance with the kind of sound effect, i.e., a characteristic of an audio feedback.

In one example, the electronic device 100 may identify a characteristic of a sound effect associated with a detected input pattern; may load a parameter value associated with the characteristic; apply the loaded parameter value when initializing each module of the basic sound effect synthesis device; and synthesizing a sound effect. For example, if the electronic device 100 detects an input pattern from the user's finger, the electronic device 100 may set a parameter value corresponding to a range touched by the finger and generate a sound effect in real-time.

An example method for generating a sound effect using a frequency is discussed below. However, it is understood that the sound effect synthesis device may generate a sound effect by applying various technology.

The feature information acquisition unit 230 may execute the feature information operation module 118 stored in the memory 110, and provide feature information as a parameter value to the sound effect synthesis unit 240. Sound effect synthesis unit 240 may use the parameter value for generating a sound effect.

In one example, the feature information acquisition unit 230 may acquire feature information of a detected input pattern. Here, the feature information may include a physical variation of the input pattern received within a certain time. For example, the feature information may include coordinate information, speed information, direction information, acceleration information, angular speed information, pressure information, and the like in which the input pattern is received during the certain time.

In one example, the feature information acquisition unit 230 may acquire feature information through a digitized input pattern value (e.g., a motion coordinate, a pressure, and the like of a user or an input tool) provided from the input reception unit 210. For example, the feature information acquisition unit 230 may confirm variation values of an input coordinate of a detected input pattern, an input speed thereof, an input direction thereof, an input acceleration thereof, an input angular speed thereof, an input pressure thereof, and the like, by comparing an initial input value of the detected input pattern and a current input value thereof using a difference of time detected by the input reception unit 210.

In one example, the feature information acquisition unit 230 may determine the confirmed feature information and extract a parameter value that is used for sound effect synthesis in the sound effect synthesis unit 240. For example, the feature information acquisition unit 230 will be able to acquire feature information at a certain time interval or in real-time, in response to a detected input pattern.

The sound effect synthesis unit 240 may read feature information generated by the feature information acquisition unit 230; alter a sound effect generated by the basic sound effect acquisition unit 220; and generate an audio signal matching the detected input pattern in real-time. For example, the sound effect synthesis unit 240 may adapt the provided feature information to a physical modeling standard.

In one example, when speed is among the provided features, a movement speed of a moved coordinate of a detected input pattern may correspond to a pitch value or an output intensity of a sound effect. For example, the output intensity of the sound effect may gradually increase as the movement speed of the detected input pattern gradually increases.

In yet a further example, when a direction of the input pattern is among the provided features and the direction is a left-to-right direction, a movement sound effect may be provided using a panning effect or a Head Related Transfer Function (HRTF) such that a balance of the output sound effect may move from the left to the right.

Also, a near-and-far effect may be provided such that it gradually sounds clearer by increasing an output intensity of the sound effect as the input pattern gets closer to an initial input coordinate; conversely, the sound effect may gradually sound less clear by decreasing the output intensity of the sound effect as the detected input pattern gets farther from the center point.

In yet a further example, when pressure information is among the provided features and a pressure of a detected input pattern increases, an output intensity of an associated sound effect may increase or a synthesis value may be adjusted to make a strong sound. And, if the pressure of the detected input pattern decreases, the output intensity of the output basic sound effect may be decreased or the synthesis value may be adjusted to make a lighter sound.

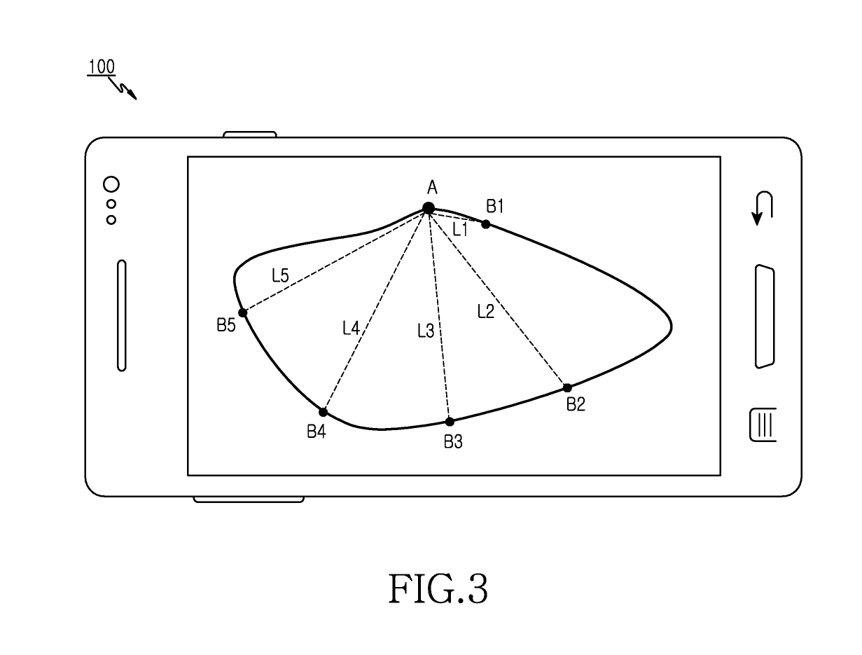

In a further example, as illustrated in FIG. 3, after storing the first portion (A) of a detected input pattern in the memory 110, the sound effect synthesis unit 240 may obtain distances (e.g., L1, L2, L3, L4, or L5) with respect to the currently detected input coordinate (e.g., B1, B2, B3, B4, or B5), and generate an audio signal in real time using the distance value. The sound effect synthesis unit 240 may be able to generate a more natural sound effect in view of the motion of the input, such as a periodical motion of drawing a circle or a motion of drawing a straight line far. For example, a volume may be gradually decreased to produce a fade-out effect as a current coordinate gets farther from the first portion (A) of the detected input pattern; and the volume may be gradually increased such that a fade-in effect may be given as the current coordinate gets closer to the first portion (A).

In a further example, the sound effect synthesis unit 240 may alter a sound effect in accordance with a detected input feature of an input pattern. In one example, if the electronic device 100 executes an application such as a memo, a text message, a paint and the like capable of detecting input by a stylus or pen, the electronic device 100 may select and output a sound effect that corresponds to a thickness of a pen. For example, when a pen is thick, the electronic device 100 may apply a low-band enhancement filter and concurrently increase a volume of an output sound effect to generate a heavy sound. And, when a pen is thin, the electronic device 100 may use a high-band enhancement filter and decrease the volume to generate a light and sharp sound. Though not illustrated, the processor 122 may include a buffer control unit for controlling the output of a sound effect synthesized by the sound effect synthesis unit 240.

In one example, the buffer control unit may temporarily store a synthesized sound effect generated by the sound effect synthesis unit 240, and output a synthesized sound effect in response to a detected input pattern. This buffer control unit may be included in, for example, the audio device 160.

In a further example, the aforementioned basic sound effect acquisition unit 220 and feature information acquisition unit 230 may be operated as one module (device). Also, this module (device) may be included in the audio device 160.

In a further example, the electronic device 100 may synthesize an audio signal in response to a detected input pattern in real-time, store the synthesized audio signal in a buffer, and provide the synthesized audio signal whenever there is a request for data necessary for playback. At this time, the sound effect synthesis unit 240 may check a quantity of previously synthesized audio data stored in the buffer before generating audio data matching each motion. If the number of sound effects previously stored in the buffer is equal to or greater than a threshold number, the sound effect synthesis unit 240 may decrease audio latency by synthetizing a lower number of sound effects or by skipping synthetizing. In this method, the electronic device 100 may provide an audio feedback minimizing the latency, in response to the input pattern.

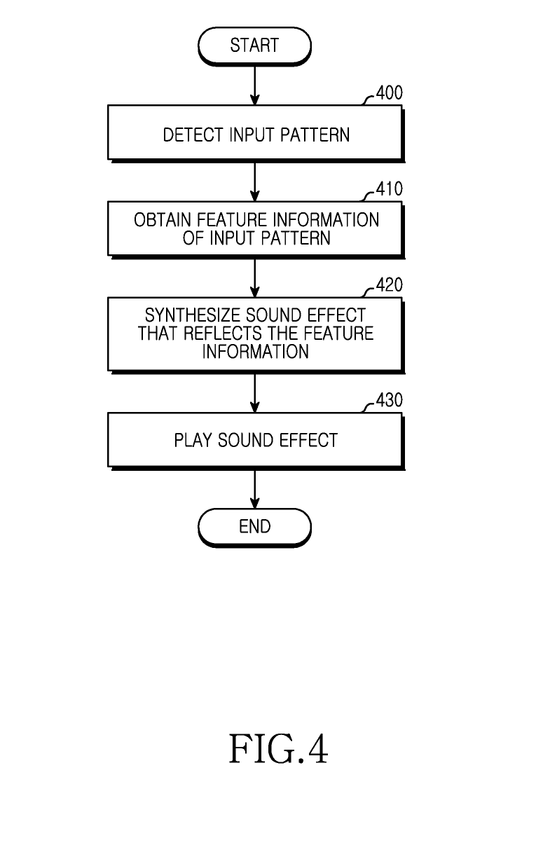

Referring to FIG. 4, in operation 400, the electronic device 100 may detect an input pattern. As noted above, an input pattern may be detected with the input reception unit 210.

In operation 410, the electronic device 100 may obtain feature information of the detected input pattern. As noted above, the feature information acquisition unit 230 may obtain the feature information as a digitized input pattern value received from the input reception unit 210.

In operation 420, the electronic device 100 may generate a synthesized sound effect that reflects the features. The sound effect may be based at least partially on a previously stored basic sound effect. In one example, the sound effect synthesis unit 240 of the electronic device 100 may be provided with features collected by the feature information acquisition unit 230. In turn, sound effect synthesis unit 240 may alter a previously stored basic sound effect and synthesize an audio signal associated with the detected input pattern in real time. Here, the basic sound effect may be stored in the memory 110 in a PCM format. The sound effect synthesis unit 240 may apply the provided feature information to a physical modeling standard to alter the basic sound effect. Thus, sound effect synthesis unit 240 may alter a basic sound effect dynamically in accordance with the features of a detected input pattern.

In operation 430, the electronic device 100 may play the synthesized sound effect. As noted above, a buffer control unit of the electronic device 100 may temporarily store a synthesized sound effect, and output the synthesized sound effect in response to a detected input pattern.

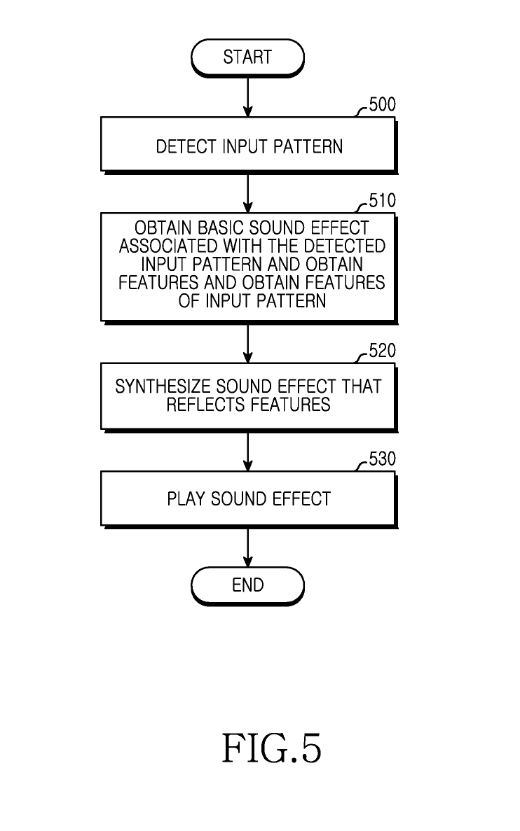

Referring now to the example method in FIG. 5, in operation 500, the electronic device 100 may detect an input pattern. As discussed above, input reception unit 210 may detect input from a user's body or an input device.

In operation 510, the electronic device 100 may obtain a basic sound effect associated with the detected input pattern, and obtain feature information of the detected input pattern. As noted above, the basic sound effect acquisition unit 220 of the electronic device 100 may synthesize a basic sound effect in accordance with a received input pattern, using a frequency synthesis method. For example, the basic sound effect acquisition unit 220 may include a basic sound effect synthesis device which is comprised of a white noise generator, an LFO, and an audio filter.

In operation 520, the electronic device 100 may synthesize a sound effect that reflects the acquired feature information. As noted above, the sound effect synthesis unit 240 may read the feature information generated by the feature information acquisition unit 230; alter a sound effect generated in the basic sound effect acquisition unit 220; and generate an audio signal matching the detected input pattern in real-time.

In operation 530, the electronic device 100 may play the synthesized sound effect.

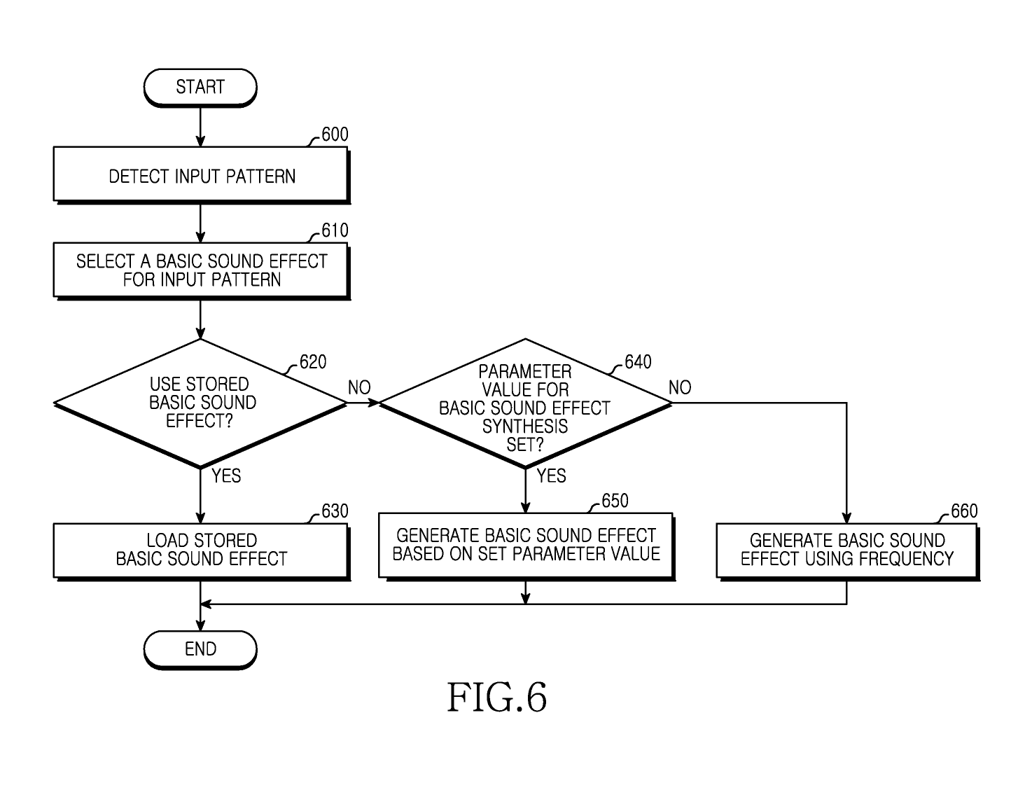

Referring now to the example of FIG. 6, in operation 600, the electronic device 100 may detect an input pattern. In operation 610, the electronic device 100 may select a basic sound effect for the detected input pattern.

In operation 620, the electronic device 100 may identify whether to use the stored basic sound effect. If the stored basic sound effect will be used, the electronic device 100 may load the stored basic sound effect in operation 630. As noted above, the basic sound effect acquisition unit 220 may provide a basic sound effect for sound effect synthesis. For example, the basic sound effect may be stored in the memory 110 in a PCM format.

If the stored basic sound effect is not used, the electronic device 100 may determine whether to set a parameter value for a basic sound effect synthesis in operation 640. If the parameter value is not set, the electronic device 100 may generate a basic sound effect using a frequency, in operation 660. If the parameter value is set, the electronic device 100 may generate a basic sound effect based on the set parameter value, in operation 650.

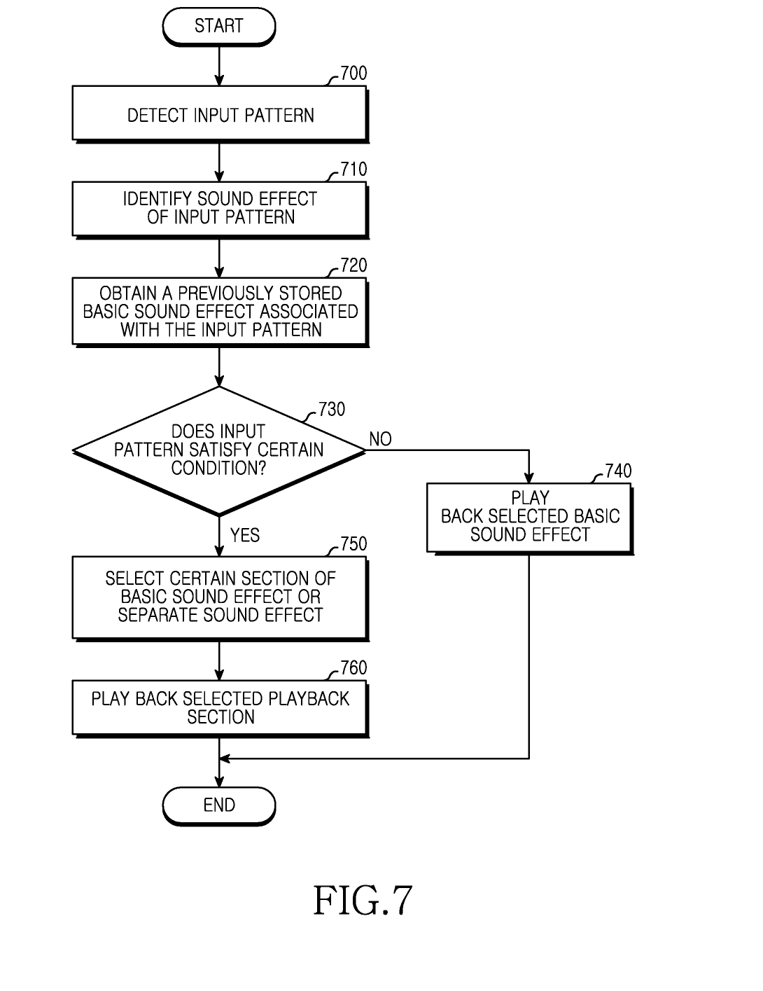

Referring to the example method in FIG. 7, in operation 700, the electronic device 100 may detect an input pattern.

In operation 710, the electronic device 100 may identify a sound effect associated with the detected input pattern.

In operation 720, the electronic device 100 may obtain a previously stored basic sound effect associated with the detected input pattern. As noted above, the basic sound effect acquisition unit 220 of the electronic device 100 may load a previously recorded basic sound effect stored in the memory 110. The memory 110 may store a variety of basic sound effects for different input patterns.

In operation 730, the electronic device 100 may identify whether the detected input pattern satisfies a certain condition. In one example, the input reception unit 210 of the electronic device 100 may identify whether the detected input pattern satisfies a certain condition. This certain condition may be a condition that a speed of the detected input pattern be equal to or is less than a threshold speed, and that a length of the input pattern be equal to or greater than a threshold length. For example, if a user draws a long line slowly or draws a circle using an application such as a memo, a text message, a paint and the like capable of accepting input from a stylus or a pen, the electronic device 100 may identify whether the aforementioned certain condition is satisfied. However, it is understood that various input patterns may be analyzed to determine whether the conditions are satisfied.

If the detected input pattern does not satisfy the certain condition, the electronic device 100 may play back the obtained basic sound effect, in operation 740. In one example, the electronic device 100 may play back all sections of the selected basic sound effect. Also, the electronic device 100 may output all sections of the selected basic sound effect in accordance with the detected input pattern.

In operation 750, if the detected input pattern satisfies the certain condition, the electronic device 100 may select a playback section within the basic sound effect or a separate sound effect.

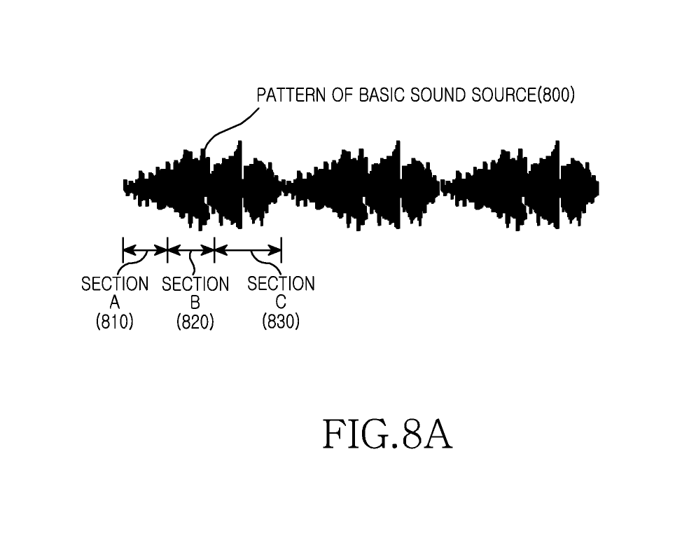

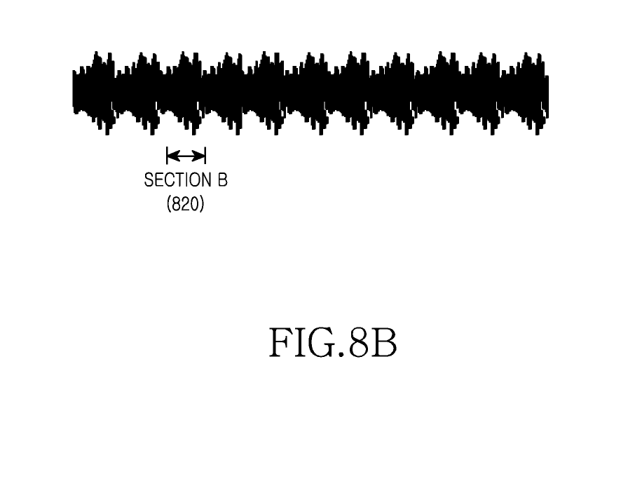

Referring now to FIG. 8A, electronic device 100 may select section B 820 as a playback section. Section B 820 may emit a certain sound within a pattern 800 of a basic sound effect. Section A 810 or Section C 830 may represent a variation of the input pattern that may have not been detected. Thus, if section A 810 or section C 830 is also played back, an unnatural or unfitting sound effect may be generated.

In operation 760, the electronic device 100 may play back the selected playback section. In one example, the electronic device 100 may play back section B 820, which is the selected playback section in this example as illustrated in FIG. 8B. In this instance, the section B 820 is a section emitting a certain sound that is fitting for the input pattern and therefore, the electronic device 100 will be able to provide a natural sound effect that is in accordance with the detected input pattern. Electronic device 100 may play back only section B 820 that is the selected, but it is understood that multiple sections may be selected. For example, the playback section may include one or more sections, and these playback sections may be combined to provide various audio feedback.

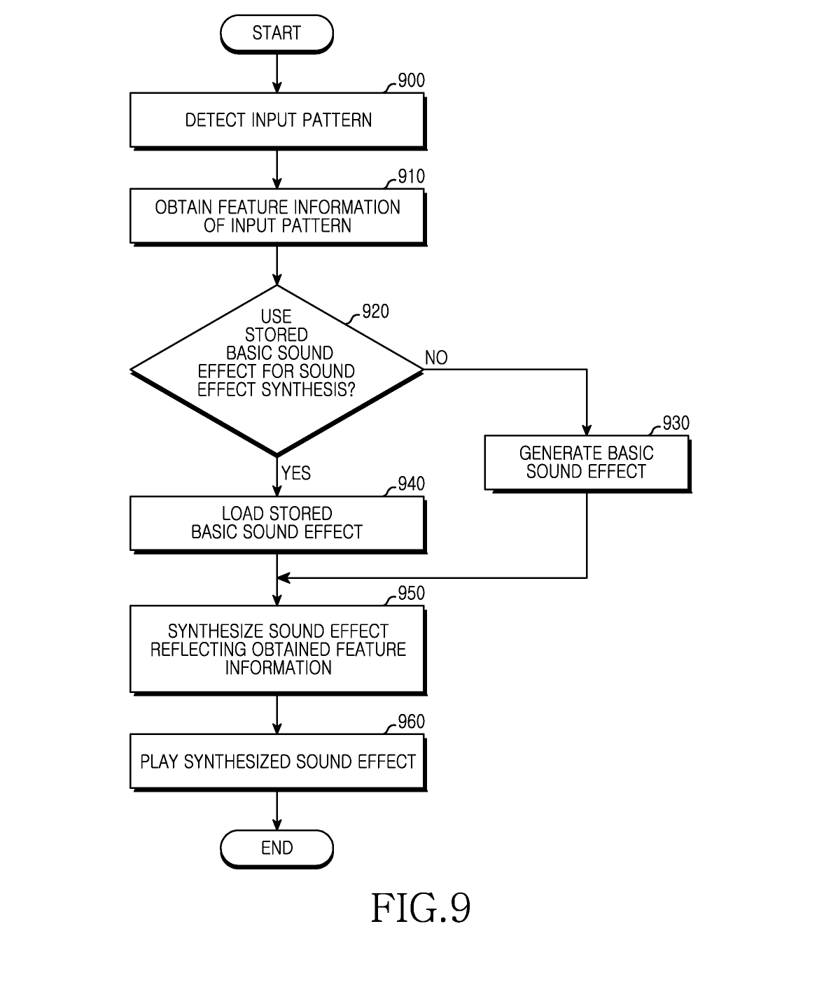

Referring now to the example in FIG. 9, in operation 900, the electronic device 100 may detect an input pattern. The input pattern may be, for example, a continuous touch input or continuous hovering input.

In operation 910, the electronic device 100 may obtain feature information of the detected input pattern.

In operation 920, the electronic device 100 may determine whether to use a stored basic sound effect for sound effect synthesis. If using the stored basic sound effect for the sound effect synthesis, in operation 940, the electronic device 100 may load the stored basic sound effect. As noted above, the electronic device 100 may output a different basic sound effect in accordance with an input pattern. For example, if a ball point pen is used to apply input, the electronic device 100 will be able to generate a ball point pen sound in accordance with the detected input pattern.

If the stored basic sound effect is not used, the electronic device 100 may generate a basic sound effect, in operation 930. As noted above, the basic sound effect may be generated using the basic sound effect acquisition unit 220.

In operation 950, the electronic device 100 may synthesize a sound effect that reflects the obtained feature information, the sound effect may be based at least partially on the basic sound effect. As noted above the basic sound effect may be altered by the sound effect synthesis unit 240.

In operation 960, the electronic device 100 may play the generated sound effect. As noted above, a buffer control unit of the electronic device 100 may temporarily store a generated sound effect and output the sound effect in response to a detected input pattern. In one example, the synthesized sound effect may be in proportion to the available capacity of the buffer memory.

The above-described embodiments of the present disclosure may be implemented in hardware, firmware or via the execution of software or computer code that may be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein may be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101. The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

What is claimed is:

1. A method in an electronic device, the method comprising:
obtaining features associated with a detected input pattern;
obtaining a basic sound effect;
synthesizing a sound effect that reflects the features associated with the input pattern, the sound effect being based at least partially on the basic sound effect; and
outputting the synthesized sound effect.

2. The method of claim 1, wherein the detected input pattern comprises a continuous touch input or a continuous hovering input.

3. The method of claim 1, wherein the features comprise a physical variation of the input pattern detected during a certain time interval.

4. The method of claim 3, wherein the physical variation comprises at least one of a coordinate variation of the detected input pattern, a speed variation, a direction variation, an acceleration variation, an angular speed variation, and a pressure variation.

5. The method of claim 1, further comprising:
increasing a volume of the synthesized sound effect as a movement of the detected input pattern approaches an initial input coordinate; and
decreasing the volume as the movement of the detected input pattern is distanced from the initial input coordinate.

6. The method of claim 1, further comprising:
checking a number of sound effects stored in an output buffer; and
decreasing an audio latency of the synthetized sound effect by synthesizing less sound effects or by skipping synthesizing, when the number of sound effects in the output buffer is equal to or greater than a threshold number.

7. The method of claim 1, wherein obtaining the basic sound effect comprises loading the basic sound effect stored in a memory of the electronic device.

8. The method of claim 7, wherein loading the basic sound effect comprises identifying whether the detected input pattern satisfies a certain condition.

9. The method of claim 8, further comprising utilizing a certain section of the basic sound effect or a separate sound effect for synthesizing the sound effect that reflects the features of the detected input pattern, when the detected input pattern satisfies the certain condition.

10. The method of claim 8, wherein the certain condition includes a speed of the detected input pattern being equal to or is less than a threshold speed and a length of the detected input pattern being equal to or greater than a threshold length.

11. The method of claim 1, wherein obtaining the basic sound effect comprises generating the basic sound effect using frequency synthesis.

12. The method of claim 11, further comprising generating the basic sound effect by reflecting a preset parameter value.

13. The method of claim 1, further comprising synthesizing the sound effect in proportion to an available capacity of a buffer memory of the electronic device.

14. An electronic device comprising:
at least one processor to:
detect an input pattern;
identify features associated with the input pattern;
obtain a basic sound effect;
synthesize a sound effect that reflects the features associated with the input pattern, the sound effect being based at least partially on the basic sound effect; and
output the synthesized sound effect.

15. The electronic device of claim 14, wherein the at least one processor to further store the synthesized sound effect temporarily in order to play the synthesized sound effect.

16. The electronic device of claim 15, wherein the at least one processor to further:
check a number of synthesized sound effects in an output buffer; and
decrease an audio latency of the synthetized sound effect by synthesizing less sound effects or by skipping, when the number of synthesized sound effects in the output buffer is equal to or greater than a threshold number.

17. The electronic device of claim 14, wherein the at least one processor to further:
increase a volume of the synthesized sound effect as a movement of the detected input pattern approaches an initial input coordinate; and
decrease the volume as the movement of the detected input pattern is distanced from the initial input coordinate.

18. The electronic device of claim 14, wherein the at least one processor to load the basic sound effect stored in a memory of the electronic device in order to obtain the basic sound effect.

19. The electronic device of claim 18, wherein the at least one processor to employ a certain section of the basic sound effect or a separate sound effect for synthesizing the sound effect that reflects the features of the detected input pattern, when the detected input pattern satisfies a certain condition.

20. The electronic device of claim 14, wherein the at least one processor to synthesize the sound effect in proportion to an available capacity of a buffer memory of the electronic device.
